(19) United States
(12) Patent Application Publication
(10) Pub. No.: US 2008/0253772 A1
(43) Pub. Date: Oct. 16, 2008

(54) Remote controller, electronic apparatus, and remote control system

(75) Inventor: Akira Katsuyama, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/080,235

(22) Filed: Apr. 1, 2008

(30) Foreign Application Priority Data
Apr. 10, 2007 (JP) P2007-103158

(51) Int. Cl. H04B 10/00

(52) U.S. Cl. 398/106

(57) ABSTRACT

A remote controller sets up a pairing via two-way communications. The remote controller contains a light-emitting unit that emits a pairing-set-up request code for requesting a pairing-set-up start using infrared rays. The remote controller also contains a communication unit that receives unique information transmitted using the radio wave in response to the pairing-set-up request code emitted from the light-emitting unit and transmits unique information of the remote controller using the radio wave. The remote controller further contains a control unit that controls the light-emitting unit and the communication unit to register the unique information received by the communication unit and to set a partner of the pairing.

### CROSS REFERENCES TO RELATED APPLICATIONS

The present invention contains subject manner related to Japanese Patent Application JP2007-103158 filed in the Japanese Patent Office on Apr. 10, 2007, the entire contents of which being incorporated herein by reference.

### BACKGROUND OF THE INVENTION

1. Field of the Invention

This invention relates to a remote controller, an electronic apparatus that is remotely controlled by the remote controller, and a remote control system using the remote controller and the electronic apparatus.

2. Description of Related Art

Recently, the remote controller using radio waves has widely proposed and utilized in order to be made hard to receive any influence by an obstacle. Radio wave has a characteristic such that diffusion thereof is higher than that of infrared rays but directivity thereof is lower than that of infrared rays. Therefore, if plural electronic apparatuses are arranged around an electronic apparatus that is object of remote control, the remote controller may control any electronic apparatus other than the electronic apparatus that is object of the remote control unintentionally. Generally, pairing between the remote controller and only a specific electronic apparatus that is object of the remote control is set up, thereby establishing communication (connection) between them.

Japanese Patent Application Publication No. 2005-328295 has disclosed a pairing-set-up method. In this method, the remote controller transmits to an electronic apparatus a pairing-set-up request code for carrying out the pairing-set-up. The electronic apparatus receives the pairing-set-up request code and transmits its identification (ID) code to the remote controller in response to the received pairing-set-up request code. The remote controller then receives the ID code from the electronic apparatus and transmits an identification (ID) code of the remote controller to the electronic apparatus in response to the received ID code of the electronic apparatus. The electronic apparatus receives the ID code from the remote controller and transmits to the remote controller an acknowledgement (ACK) code indicating that the ID code of the remote controller is correctly received to register the remote controller as a partner of the pairing. Finally, the remote controller receives the ACK code from the electronic apparatus and registers the electronic apparatus as a partner of the pairing based on the received ACK code.

### SUMMARY OF THE INVENTION

The pairing-set-up method disclosed in Japanese Patent Application Publication No. 2005-328295, however, may transmit a pairing-set-up request code to any electronic apparatuses around an electronic apparatus that is object of remote control if the pairing is set up using radio wave, as described above. If so, the plural electronic apparatuses each receiving the pairing-set-up request code transmit response signals to the remote controller. It is difficult to set up the pairing one-to-one surely. The remote controller may even set up the pairing with any unintentional electronic apparatuses.

It is desirable to present a remote controller, an electronic apparatus, and a remote control system in which the pairing may be surely set up between the remote controller and the electronic apparatus that is object of remote control.

According to an embodiment of the present invention, there is provided a remote controller that sets up a pairing via two-way communications. The remote controller contains a light-emitting unit that emits a pairing-set-up request code for requesting a pairing-set-up start using infrared rays, a communication unit that receives unique information transmitted using the radio wave in response to the pairing-set-up request code emitted from the light-emitting unit and transmits unique information of the remote controller using the radio wave, and a control unit that controls the light-emitting unit and the communication unit to register the unique information received by the communication unit and to set a partner of the pairing.

The remote controller sets up a pairing with an electronic apparatus to be remotely controlled via two-way communications. The light-emitting unit emits the pairing-set-up request code for requesting the pairing-set-up start to the electronic apparatus using infrared rays. The communication unit receives unique information of the electronic apparatus transmitted from the electronic apparatus using the radio wave in response to the pairing-set-up request code emitted from the light-emitting unit and transmits unique information of the remote controller to the electronic apparatus using the radio wave. The control unit controls the light-emitting unit and the communication unit to register the unique information of the electronic apparatus that the communication unit has received and to set the electronic apparatus relative to the registered unique information as a partner of the pairing.

In this embodiment of the invention, when the remote controller sets up the pairing with the electronic apparatus to be remotely controlled, at an initial communication stage, the remote controller transmits the pairing-set-up request code to the specific electronic apparatus to be remotely controlled using infrared rays. Since the infrared rays have higher directivity than that of radio wave, the remote controller emits the infrared rays toward the specific electronic apparatus for which the pairing-set-up is executed, so that the pairing-set-up request code can be transmitted to only the specific electronic apparatus. For example, even if plural electronic apparatuses are arranged around the specific electronic apparatus for which the pairing-set-up is executed, the remote controller can emit the pairing-set-up request code toward only the specific electronic apparatus for which the pairing-set-up is executed. This enables the remote controller to set up the pairing surely with the specific electronic apparatus.

The remote controller may transmit the unique information of the remote controller to the specific electronic apparatus together with the pairing-set-up request code using the infrared rays.

According to another embodiment of the present invention, there is provided an electronic apparatus that is remotely controlled and sets up a pairing via two-way communications. The electronic apparatus contains a light-receiving unit that receives a pairing-set-up request code for requesting a pairing-set-up start using infrared rays. The electronic apparatus also contains a communication unit that transmits unique information of the electronic apparatus using the radio wave in response to the pairing-set-up request code received by the light-receiving unit and receives unique information transmitted using the radio wave. The electronic apparatus further contains a control unit that controls the light-receiving unit and the communication unit to register the unique information received by the communication unit and to set a partner of the pairing.

The electronic apparatus is remotely controlled by a remote controller and sets up a pairing with the remote controller via two-way communications. The light-receiving unit receives a pairing-set-up request code for requesting a pairing-set-up start transmitted from the remote controller using infrared rays. The communication unit transmits unique information of the electronic apparatus to the remote controller using the radio wave in response to the pairing-set-up request code received by the light-receiving unit and receives unique information of the remote controller transmitted from the remote controller using the radio wave. The control unit controls the light-receiving unit and the communication unit to register the unique information of the remote controller received by the communication unit and to set the remote controller as a partner of the pairing.

In this embodiment, when the electronic apparatus to be remotely controlled sets up a pairing with a remote controller, at an initial communication stage, the electronic apparatus to be remotely controlled receives the pairing-set-up request code from the remote controller using infrared rays. Since the infrared rays have higher directivity than that of radio wave, even if plural electronic apparatuses are arranged around the specific electronic apparatus for which the pairing-set-up is executed, the electronic apparatus to be remotely controlled by the remote controller can receive the pairing-set-up request code. This enables the electronic apparatus to set up the pairing surely with the remote controller.

If the remote controller transmits the unique information of the remote controller together with the pairing-set-up request code using the infrared rays, the electronic apparatus may receive the unique information of the remote controller and the pairing-set-up request code by its light-receiving unit.

According to further embodiment of the present invention, there is provided a remote control system containing a remote controller, and an electronic apparatus that is remotely controlled by the remote controller. The remote controller sets up a pairing with the electronic apparatus via two-way communications. The remote controller includes a light-emitting unit that emits a pairing-set-up request code for requesting a pairing-set-up start to the electronic apparatus using infrared rays. The remote controller also includes a first communication unit that receives unique information of the electronic apparatus transmitted from the electronic apparatus using the radio wave in response to the pairing-set-up request code emitted from the light-emitting unit and transmits unique information of the remote controller to the electronic apparatus using the radio wave. The remote controller further includes a first control unit that controls the light-emitting unit and the first communication unit to register the unique information of the electronic apparatus received by the first communication unit and to set the electronic apparatus as a partner of the pairing. The electronic apparatus includes a light-receiving unit that receives the pairing-set-up request code for requesting the pairing-set-up start transmitted from the remote controller using infrared rays. The electronic apparatus also includes a second communication unit that transmits unique information of the electronic apparatus to the remote controller using the radio wave in response to the pairing-set-up request code received by the light-receiving unit and receives the unique information of the remote controller transmitted from the remote controller using the radio wave. The electronic apparatus further includes a second control unit that controls the light-receiving unit and the second communication unit to register the unique information of the remote controller received by the second communication unit and to set the remote controller as a partner of the pairing.

In this embodiment of the invention, when a pairing between the remote controller and the electronic apparatus to be remotely controlled sets up, at an initial communication stage, the remote controller transmits the pairing-set-up request code to the specific electronic apparatus for which the pairing-set-up is executed using infrared rays. Since the infrared rays have higher directivity than that of radio wave, the remote controller emits the infrared rays toward the specific electronic apparatus for which the pairing-set-up is executed, so that the pairing-set-up request code can be transmitted to only the specific electronic apparatus. For example, even if plural electronic apparatuses are arranged around the specific electronic apparatus for which the pairing-set-up is executed, the remote controller can emit the pairing-set-up request code toward only the specific electronic apparatus for which the pairing-set-up is executed. This enables the remote control system to set up the pairing surely between the remote controller and the specific electronic apparatus.

The unique information of the remote controller is transmitted to the electronic apparatus using the infrared rays together with the pairing-set-up request code. In this case, the electronic apparatus receives the unique information of the remote controller and the pairing-set-up request code by its light-receiving unit.

The radio wave includes electromagnetic waves with frequencies from a very-low-frequency radio wave to far-infrared through extremely high frequency (EHF) and a submilimeter wave.

The concluding portion of this specification particularly points out and directly claims the subject matter of the present invention. However, those skilled in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1 is a diagram for showing a configuration of an embodiment of a remote control system according to the present invention;

FIG. 2 is a block diagram for showing a configuration of an embodiment of a remote controller according to the present invention;

FIG. 3 is a block diagram for showing a configuration of an embodiment of an electronic apparatus according to the present invention;

FIG. 4 is a flowchart for showing operations of the remote control system; and

FIG. 5 is a flowchart for showing operations of another embodiment of the remote control system according to the present invention.

### DESCRIPTION OF THE PREFERRED EMBODIMENTS

The following will describe embodiments of the present invention with reference to the drawings.

### (Configuration of Remote Control System)

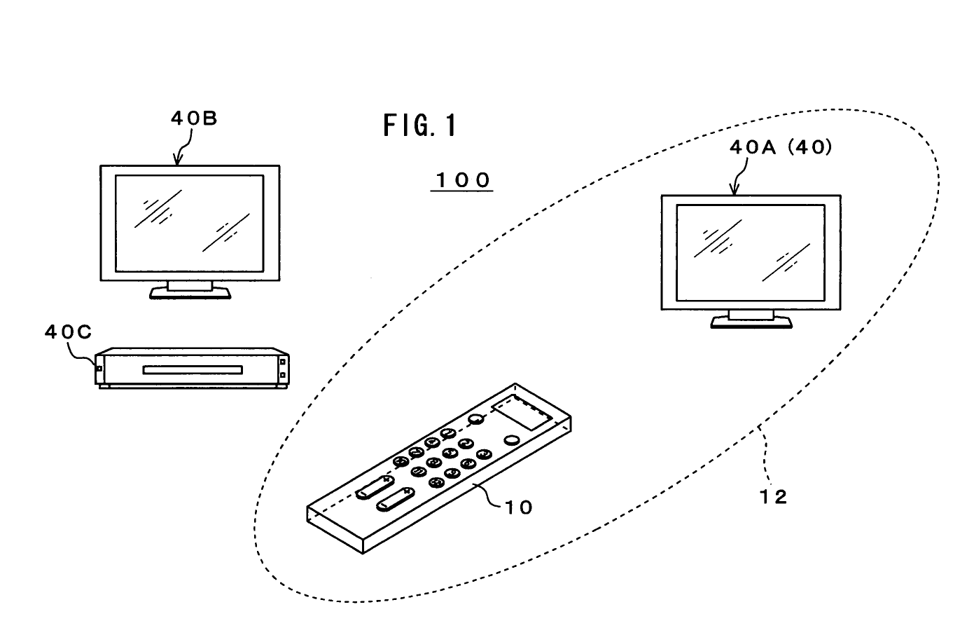

FIG. 1 shows a configuration of an embodiment of a remote control system 100 according to the present invention. The remote control system 100 contains an electronic apparatus 40 such as a television, a DVD (Digital Versatile Disc)/video recorder, an audio apparatus and the like and a remote controller 10 which controls the electronic apparatus 40 remotely. This remote control system 100 carries out two-way communications between the remote controller 10 and the electronic apparatus 40 using infrared rays and radio waves on an occasion of pairing-set-up and carries out one-way communication from the remote controller 10 to the electronic apparatus 40 using radio waves on an occasion of a normal remote control after the pairing-set-up.

For example, as shown in FIG. 1, if the remote controller 10 sets up the pairing with an specific electronic apparatus 40A among a plurality of located electronic apparatuses 40A, 40B, 40C, the remote controller 10 uses also the infrared rays having high directivity, so that the remote controller 10 can set up a pairing 12 with the specific electronic apparatus 40A with directing a tip portion (light-emitting unit) of the remote controller 10 to a direction of the specific electronic apparatus 40A for which the pairing-set-up is executed. Also, the remote controller 10 operates at a position where the specific electronic apparatus 40A for which the pairing-set-up is executed stays within a communication range of the radio waves transmitted from the remote controller 10.

### (Configuration of Remote Controller)

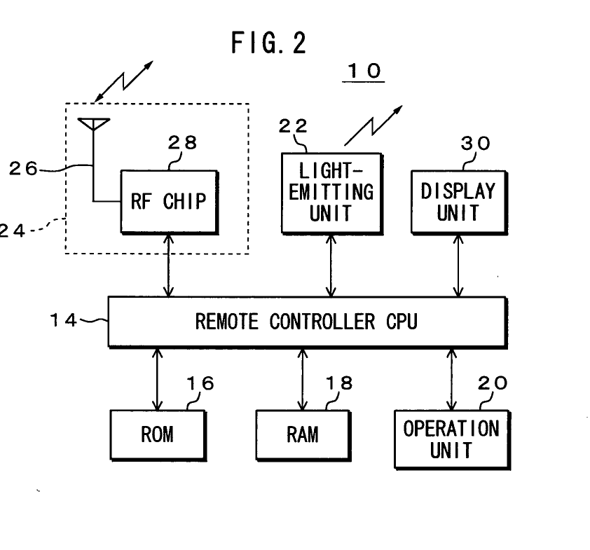

The following will describe a configuration of an embodiment of a remote controller 10 according to the invention. FIG. 2 shows a configuration of the remote controller 10.

The remote controller 10 includes a remote controller central processing unit (CPU) 14 which carries out the control of the whole remote controller 10. To the remote controller CPU 14, a read only memory (ROM) 16, a random access memory (RAM) 18, an operation unit 20, a light-emitting unit 22, a remote control communication unit 24, and a display unit 30 are respectively connected. The ROM 16 stores various kinds of programs for operating the remote controller 10 and data or the like that may be necessary for processing. The RAM 18 is used mainly for a working area of various kinds of processes by temporarily storing and saving, for example, data obtained when performing various kinds of processes in the remote controller CPU 14. The remote controller CPU 14 performs predetermined processing by executing the program stored in the ROM 16. The remote controller CPU 14, the ROM 16, and the RAM 18 constitutes the control unit.

Also, the ROM 16 stores format information assigned to every maker, model information assigned to every category (for every electronic apparatus 40), and function information (code signal) assigned to every control function (for every operation content). Further, the ROM 16 stores a pairing-set-up request code for requesting a pairing-set-up start, which is used at the time of the pairing-set-up, a unique remote control ID code (device address, unique information) assigned to every remote controller 10, and the like. The remote control ID code is also used for an acknowledge code in which an electronic apparatus ID code is added to the remote control ID code, which will be described later.

The operation unit 20 is constituted by a pairing-set-up key for shifting the remote controller CPU 14 to a pairing-set-up operation and a plurality of operation keys for carrying out the normal remote control of the electronic apparatus 40. When a user pushes the pairing-set-up key down, the remote controller CPU 14 shifts the operation of the remote controller 10 to the pairing-set-up by detecting an output signal in response to the pairing-set-up key and reads the pairing-set-up request code out of the ROM 16 to supply it to the light-emitting unit 22.

The light-emitting unit 22 is constituted by a light-emitting element which emits light in an infrared region, for example, by an infrared light-emitting diode (LED) and transmits the pairing-set-up request code received from the remote controller CPU 14 to the electronic apparatus 40 as an infrared communication signal. The infrared rays emitted by the light-emitting unit 22 have high directivity, so that the remote controller 10 can transmit the pairing-set-up request code to only a specific electronic apparatus 40A for which the pairing-set-up is executed.

The remote control communication unit 24 includes an RF chip 28 and an RF antenna 26 connected to this RF chip 28, and carries out a two-way communications using radio waves to the electronic apparatus 40 for which the pairing-set-up is executed. The RF chip 28 performs amplification and modulation processes on the pairing-set-up request code received from the remote controller CPU 14 and supplies it to the RF antenna 26. The RF antenna 26 transmits a communication signal based on the received pairing-set-up request code to the electronic apparatus 40 using radio waves. Further, the RF antenna 26 receives a communication signal (for example, ID code of the electronic apparatus 40 or ACK code) which is transmitted from the electronic apparatus 40 using radio waves. The RF chip 28 performs amplification and demodulation processes on the received communication signal and supplies it to the remote controller CPU 14. For the radio waves, a frequency of, for example, 900 MHz band, 2.4 GHz band or the like is used.

The display unit 30 constitutes a notification unit and is constituted by a display of, for example, a liquid crystal display (LCD) or the like. The display unit 30 carries out an error display based on a control signal received from the remote controller CPU 14 if the pairing-set-up is not performed correctly, or carries out a pairing completion display if the pairing-set-up is performed correctly. Also, in case of controlling the electronic apparatus 40 remotely in a normal stage, characters, numbers, reference numerals and the like corresponding to the operation contents assigned to the pushed-down operation keys are displayed thereon.

### (Configuration of Electronic Apparatus)

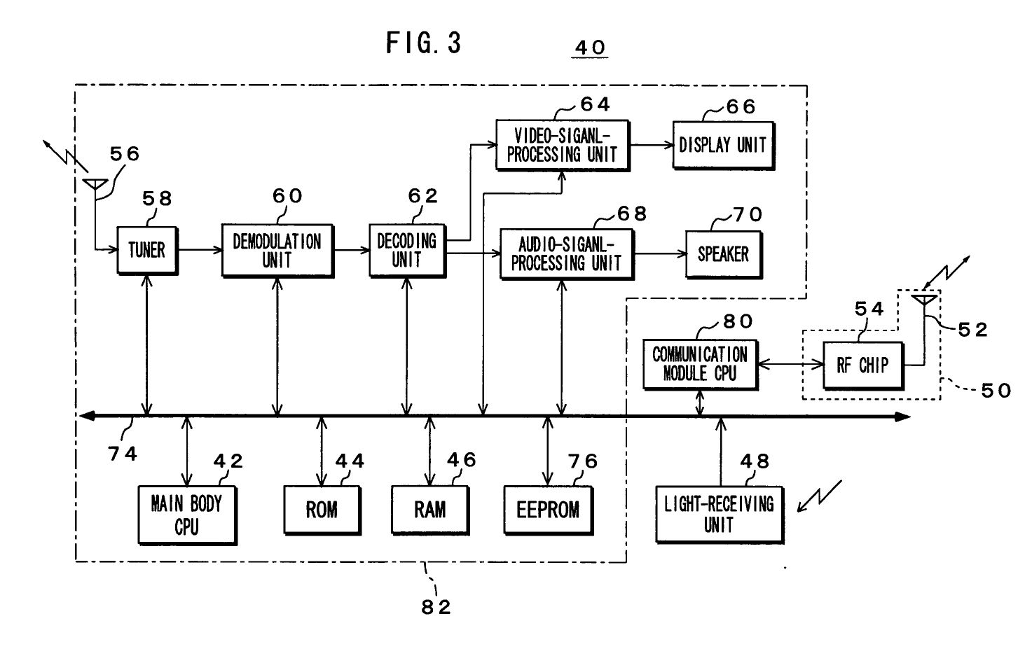

The following will describe a configuration of an embodiment of an electronic apparatus 40 according to the invention. FIG. 3 shows a configuration of the electronic apparatus 40.

As shown in FIG. 3, the electronic apparatus 40 includes an electronic apparatus main body 82 which functions as a display device such as a television. The electronic apparatus main body 82 contains a main body CPU 42, a ROM 44, a RAM 46, an electrically erasable programmable read only memory (EEPROM) 76, a broadcast-signal-receiving antenna 56, a tuner 58, a demodulation unit 60, a decoding unit 62, a video-signal-processing unit 64, a display unit 66, an audio-signal-processing unit 68, and a speaker 70.

The main body CPU 42 controls the whole electronic apparatus main body 82, reads basic programs and various kinds of application programs out of the ROM 44 through a bus 74, and develops them to the RAM 46 and the EEPROM 76, thereby enabling the electronic apparatus main body 82 to execute various kinds of processes. The main body CPU 42, the ROM 44, the RAM 46, and the EEPROM 76 constitutes a control unit.

Also, the ROM 44 or the EEPROM 76 stores a unique electronic apparatus ID code (unique information) assigned to every electronic apparatus 40, which is used at the time of the pairing-set-up, an ACK code issued as a response signal when receiving the acknowledge code of the remote controller 10 correctly, and the like.

The broadcast-signal-receiving antenna 56 receives the broadcast signal and supplies the received broadcast signal to the tuner 58. The tuner 58 tunes the broadcast signals to a desired channel based on the instructions from the main body CPU 42 and supplies the tuned broadcast signal to the demodulation unit 60.

The demodulation unit 60 demodulates the tuned broadcast signal and obtains a transport stream. Then, the demodulation unit 60 separates compressed video data and compressed audio data from the transport stream and supplies the respective compressed video data and compressed audio data to the decoding unit 62. The transport stream by the digital broadcast is constituted by multiplexing compressed data in which video signals and audio signals of a plurality of programs (broadcast programs) are compressed, for example, according to the Moving Picture Experts Group Layer 2 (MPEG2) system and various kinds of additional information.

The decoding unit 62 decodes the respective compressed video data and compressed audio data that are received from the demodulation unit 60, supplies the video data to the video-signal-processing unit 64 and the audio data to the audio-signal-processing unit 68.

The video-signal-processing unit 64 performs the vertical-horizontal synchronizing signal detection and various kinds of video signal processing on the video data received from the decoding unit 62 and outputs the processed data to the display unit 66. The display unit 66 is constituted, for example, by a display of a cathode ray tube (CRT), a liquid crystal display (LCD), a plasma display panel (PDP) or the like and displays an image based on the output signal received from the video-signal-processing unit 64.

The audio-signal-processing unit 68 performs desired audio signal processing on the digital audio data received from the decoding unit 62, converts the process audio data to an analog audio signal, and outputs sounds from the speaker 70.

Also, the electronic apparatus 40 also includes, as shown in FIG. 3, a communication module CPU 80, a light-receiving unit 48, and a main body communication unit 50. These units are connected to the bus 74.

The light-receiving unit 48 is constituted by a light-receiving element, an amplifier and the like. The light-receiving unit 48 receives the infrared communication signal from the remote controller 10 and amplifies it to obtain the pairing-set-up request code by removing the carrier component therefrom. The light-receiving unit 48 then supplies this code to the main body CPU 42.

The main body communication unit 50 includes an RF chip 54 and an RF antenna 52 connected to this RF chip 54. The main body communication unit 50 performs two-way communications using radio waves to the remote controller 10 for which the pairing-set-up is executed.

The RF chip 54 of the main body communication unit 50 is connected to the communication module CPU 80. The RF chip 54 performs modulation process on the electronic apparatus ID code and the ACK code received from the communication module CPU 80 and supplies them to the RF antenna 52. The RF antenna 52 then transmits a communication signal based on the electronic apparatus ID code or the like to the remote controller 10 using radio waves. Also, the RF antenna 52 receives an acknowledge code transmitted from the remote controller 10 using radio waves and the RF chip 54 performs any amplification and modulation processes on the received acknowledge code.

The communication module CPU 80 carries out observation of the power supply state of the electronic apparatus main body 82 or controls operations of the RF chip 54. Also, the communication module CPU 80 converts the acknowledge code modulated in the RF chip 54 to a format of the remote control code using infrared rays and supplies it to the main body CPU 42.

The main body CPU 42 of the electronic apparatus main body 82 sets up the pairing based on the pairing-set-up request code or the acknowledge code supplied by the same format from the light-receiving unit 48 and the communication module CPU 80, respectively. Then, a remote controller ID code included in the acknowledge code is stored in a memory such as a ROM and this remote controller 10 is registered and controlled as a partner of the pairing.

### (Operation of Pairing-Set-Up)

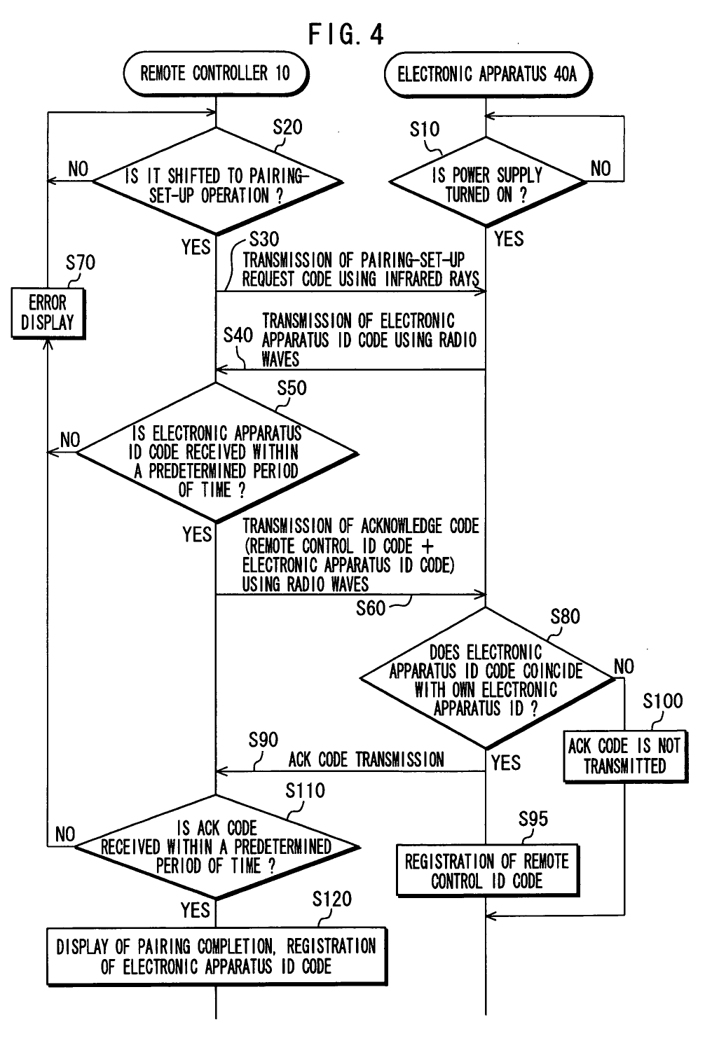

The following will describe the operations of the remote controller 10 and the specific electronic apparatus 40A when the pairing sets up between the remote controller 10 and the specific electronic apparatus 40A. FIG. 4 shows the operations of the remote control system 100 when the pairing sets up.

First, as shown in FIG. 4, it is judged at step S10 whether or not the power supply of the electronic apparatus 40 for which the pairing-set-up is executed is turned on. If the power supply of the electronic apparatus 40 is OFF, a communication signal is not received from the remote controller 10, so that the pairing does not set up in this OFF state.

The remote controller 10 judges at step S20 whether or not it is shifted to a pairing-set-up operation. This can be judged, for example, based on whether or not the remote controller CPU 14 detects the output signal generated by pushing down the pairing-set-up key provided in the remote controller 10. When it is shifted to the pairing-set-up operation, the operation goes to step S30.

At the step S30, when it is shifted to the pairing-set-up operation, the remote controller 10 reads the pairing-set-up request code out of the ROM 16 and transmits it to the electronic apparatus 40 using infrared rays. At that time, it is possible, by emitting the pairing-set-up request code to a direction of the specific electronic apparatus 40A for which the pairing-set-up is executed from the remote controller 10, to transmit the pairing-set-up request code only to the specific electronic apparatus 40A for which the pairing-set-up is executed even if plural electronic apparatuses 40A, 40B, 40C are located circumferentially (see FIG. 1).

At step S40, when receiving the infrared pairing-set-up request code, the specific electronic apparatus 40A reads the unique electronic apparatus ID code assigned to the specific electronic apparatus 40A out of the ROM 44 and transmits it to the remote controller 10 using radio waves.

At step S50, the remote controller 10 judges whether or not the electronic apparatus ID code is received within a predetermined period of time. When the remote controller 10 receives the electronic apparatus ID code within the predetermined period of time, the operation goes to step S60 while when the remote controller 10 does not receive the electronic apparatus ID code within the predetermined period of time, the operation goes to step S70.

At the step S70, the remote controller 10 displays, for example, characters of “error” on a screen of its display unit 30 to notify the user that the pairing-set-up is not executed correctly.

On the other hand, at the step S60, the remote controller 10 reads the acknowledge code including its own remote control ID code and the received electronic apparatus ID code out of the ROM 16 and transmits the acknowledge code to the specific electronic apparatus 40A using radio waves.

At step S80, the specific electronic apparatus 40A judges whether or not the electronic apparatus ID code included in the acknowledge code coincides with its own electronic apparatus ID code. When the specific electronic apparatus 40A judges that the electronic apparatus ID code coincides with its own electronic apparatus ID code, the operation goes to step S90. On the other hand, when the specific electronic apparatus 40A judges that the electronic apparatus ID code does not coincide with its own electronic apparatus ID code, the received electronic apparatus ID code is scrapped as being invalid and the operation goes to step S100.

At the step S90, the specific electronic apparatus 40A transmits to the remote controller 10 an ACK code notifying that the acknowledge code transmitted from the remote controller 10 is received correctly. Also, when the electronic apparatus ID code coincides with its own electronic apparatus ID code, at step S95, the specific electronic apparatus 40A stores the remote controller ID code transmitted from the remote controller 10 in the ROM 44, and registers and controls the remote controller 10 having this remote controller ID code as a partner of the pairing.

At the step S100, the specific electronic apparatus 40A does not transmit the ACK code to the remote controller 10 because the acknowledge code is not received correctly from the remote controller 10 and the specific electronic apparatus 40A becomes in a standby state until the pairing-set-up starts once again on a side of the remote controller 10.

At step S110, the remote controller 10 judges whether or not the ACK code is received within a predetermined period of time. When the remote controller 10 judges that the ACK code is received within the predetermined period of time, the operation goes to step S120 and when the remote controller 10 judges that the ACK code is not received within the predetermined period of time, the operation goes to step S70.

At the step S70, the remote controller 10 displays, for example, characters of “error” on the screen of its display unit 30 and notifies the user that the pairing-set-up is not executed correctly.

On the other hand, when the ACK code is received, at the step S120, the remote controller 10 displays, for example, characters of “pairing completion” on the screen of its display unit 30 and notifies the user that the pairing-set-up is executed correctly. Also, the remote controller 10 stores the electronic apparatus ID code which has been received at the step S50 in the ROM 16 and registers and controls the specific electronic apparatus 40A having this electronic apparatus ID code as a partner of the pairing.

As explained above, according to this embodiment, the remote controller 10 transmits the pairing-set-up request code to the electronic apparatus 40A using infrared rays in an initial communication stage when the pairing-set-up is executed between the remote controller 10 and the electronic apparatus 40A. The infrared rays have higher directivity than that of the radio wave, so that by emitting the infrared rays directed to the direction of the specific electronic apparatus 40A for which the pairing-set-up is executed, it does not happens that a response signal (electronic apparatus ID code or the like) is transmitted back from an electronic apparatus other than the specific electronic apparatus 40A. As a result thereof, it is possible for the remote controller 10 to carry out a limited communication to the specific electronic apparatus 40A and it is possible, even if a plurality of electronic apparatuses 40 are located, to prevent the pairing with an electronic apparatus 40, which is not intended, from being set up.

Also, the electronic apparatus 40A receiving the pairing-set-up request code carries out communication only with the remote controller 10, which has shifted to the pairing-set-up operation, so that it is possible to transmit the electronic apparatus ID code and the ACK code to the remote controller 10 using radio waves.

The following will describe another embodiment of the present invention with reference to the drawings. Although the remote controller 10 has transmitted the ID code of the remote controller 10 to the electronic apparatus 40 using radio waves in the above embodiment, the remote controller 10 transmits the ID code of the remote controller 10 to the electronic apparatus 40 using infrared rays in this embodiment. It is to be noted that other configurations and operations of the remote controller 10 and the electronic apparatus 40 (40A) are same as those of the embodiment mentioned above, so that detailed explanations thereof will be omitted by putting the same reference numerals on the common constituent elements.

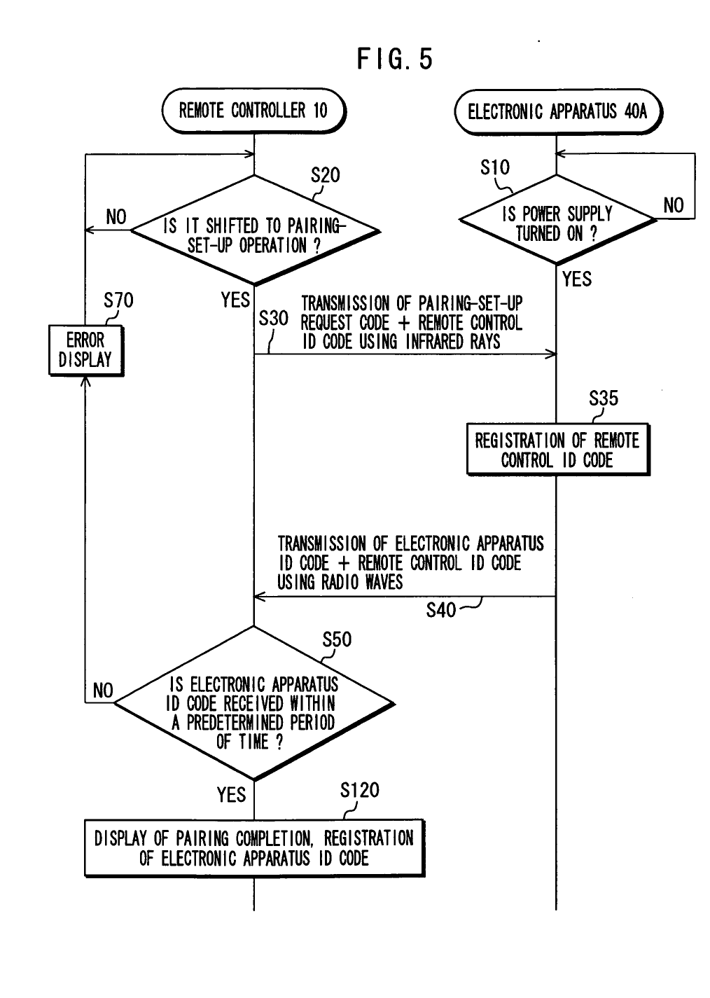

FIG. 5 shows operations of the remote control system 100 when executing the pairing-set-up.

First, as shown in FIG. 5, it is judged at step S10 whether or not the power supply of the specific electronic apparatus 40A for which the pairing-set-up is executed is turned on. Also, the remote controller 10 judges at step S20 whether or not it is shifted to the pairing-set-up operation. When it is shifted to the pairing-set-up operation, the operation goes to step S30.

When it is shifted to the pairing-set-up operation, at the step S30, the remote controller 10 reads the pairing-set-up request code and the remote controller ID code out of the ROM 16 and transmits them to the specific electronic apparatus 40A using infrared rays.

At step S35, the specific electronic apparatus 40A stores the received remote control ID code in the ROM 44 and registers and controls the remote controller 10 having this remote controller ID code as a partner of the pairing.

At step S40, the specific electronic apparatus 40A reads the electronic apparatus ID code out of the ROM 44 based on the pairing-set-up request code received from the remote controller 10 and transmits to the remote controller 10 using radio waves the electronic apparatus ID code adding the remote controller ID code received at the step S30.

The remote controller 10 judges at step S50 whether or not the electronic apparatus ID code is received within a predetermined period of time. When remote controller 10 judges that the electronic apparatus ID code is received within the predetermined period of time, the operation goes to step S120 while when remote controller 10 judges that the electronic apparatus ID code is not received within the predetermined period of time, the operation goes to step S70.

At the step S120, the remote controller 10 displays, for example, characters of “pairing completion” on the screen of its display unit 30 and notifies the user that the pairing-set-up is executed correctly. Also, the remote controller 10 stores the received electronic apparatus ID code in the ROM 16 and registers and controls the specific electronic apparatus 40A having this electronic apparatus ID code as a partner of the pairing.

On the other hand, at the step S70, the remote controller 10 displays, for example, characters of “error” on the screen of its display unit 30 and notifies the user that the pairing-set-up is not executed correctly.

According to this embodiment, the ID code of the remote controller is also transmitted at the initial communication stage of the pairing-set-up, so that it is possible to simplify the process of the pairing-set-up.

It is to be noted that the technical scope of the present invention is not limited by the embodiments mentioned above and includes a scope added with various kinds of modifications to the embodiments mentioned above within a scope not departing from the spirit of the present invention.

Although the main body CPU 42 has executed the pairing-set-up on the side of the electronic apparatus 40 mentioned above, the communication module CPU 80 may execute the pairing-set-up. In this case, the light-receiving unit 48 will supply the received pairing-set-up request code to the communication module CPU 80. In addition, it is also allowed for the communication module CPU 80 to be integrally constituted by being built-in in the RF chip 54.

With respect to the configuration of the notification unit for notifying the pairing-set-up state, it is not limited to the configuration for displaying messages on the screen of the display unit 30 of the remote controller 10. For example, it is also allowed to notify the pairing-set-up state to the user by providing an LED on the remote controller 10 so as to blink this LED, so as to light-emit the LED or the like when the pairing-set-up is not executed correctly.

Although the pairing has set up between the remote controller 10 and the electronic apparatus 40 in the embodiments mentioned above, the present invention can be applied also to a case in which the pairing sets up between the remote controller 10 and an illumination apparatus or between the remote controller 10 and an air conditioner apparatus.

Further, it is also possible to control a plurality of electronic apparatuses remotely according to the embodiments of the remote controller 10 of the present invention by executing the pairing-set-up such as the embodiments mentioned above repeatedly to other electronic apparatuses. At that time, it is also preferable to provide a changeover key on the remote controller 10 for switching the plurality of electronic apparatuses, and to select any one of the plurality of the electronic apparatuses by selecting the changeover key, thereby making the plurality of electronic apparatuses to be remotely controllable.

It should be understood by those skilled in the art that various modifications, combinations, sub-combinations and alterations may occur depending on design requirements and other factors insofar as they are within the scope of the appended claims or the equivalents thereof.

What is claimed is:

1. A remote controller that sets up a pairing via two-way communications, the remote controller comprising:
a light-emitting unit that emits a pairing-set-up request code for requesting a pairing-set-up start using infrared rays;
a communication unit that receives unique information transmitted using the radio wave in response to the pairing-set-up request code emitted from the light-emitting unit and transmits unique information of the remote controller using the radio wave; and
a control unit that controls the light-emitting unit and the communication unit to register the unique information received by the communication unit and to set a partner of the pairing.

2. The remote controller according to claim 1 wherein when receiving the unique information, the communication unit transmits an acknowledge code including the unique information of the remote controller and the received unique information using the radio wave.

3. The remote controller according to claim 1 further comprising a notification unit that notifies a state of the pairing-set-up processing,
wherein the notification unit notifies that the pairing-set-up is not correctly performed when the remote controller receives no unique information transmitted in response to the pairing-set-up request code within a period of time since the light-emitting unit has emitted the pairing-set-up request code.

4. The remote controller according to claim 1 further comprising a notification unit that notifies a state of the pairing-set-up processing,
wherein the notification unit notifies that the pairing-set-up is completed when the communication unit receives a response code indicating a correct receipt of the unique information of the remote controller.

5. A remote controller that sets up a pairing via two-way communications, the remote controller comprising:
a light-emitting unit that emits a pairing-set-up request code for requesting a pairing-set-up start and unique information of the remote controller using infrared rays;
a communication unit that receives unique information transmitted using the radio wave in response to the pairing-set-up request code emitted from the light-emitting unit; and
a control unit that controls the light-emitting unit and the communication unit to register the unique information received by the communication unit and to set a partner of the pairing.

6. An electronic apparatus that is remotely controlled and sets up a pairing via two-way communications, the electronic apparatus comprising:
a light-receiving unit that receives a pairing-set-up request code for requesting a pairing-set-up start transmitted using infrared rays;
a communication unit that transmits unique information of the electronic apparatus using the radio wave in response to the pairing-set-up request code received by the light-receiving unit and receives unique information transmitted using the radio wave; and
a control unit that controls the light-receiving unit and the communication unit to register the unique information received by the communication unit and to set a partner of the pairing.

7. The electronic apparatus according to claim 6 wherein the communication unit receives an acknowledge code including the unique information of the electronic apparatus and the received unique information; and
wherein the communication unit transmits a response code indicating that the acknowledge code is correctly received when the unique information of the electronic apparatus included in the received acknowledge code agree with the internal unique information.

8. An electronic apparatus that is remotely controlled and sets up a pairing via two-way communications, the electronic apparatus comprising:
a light-receiving unit that receives a pairing-set-up request code for requesting a pairing-set-up start and unique information, which are transmitted using infrared rays;
a communication unit that transmits unique information of the electronic apparatus using the radio wave in response to the pairing-set-up request code received by the light-receiving unit; and
a control unit that controls the light-receiving unit and the communication unit to register the unique information received by the light-receiving unit and to set a partner of the pairing.

9. A remote control system comprising:
a remote controller; and
an electronic apparatus that is remotely controlled by the remote controller, the remote controller setting up a pairing with the electronic apparatus via two-way communications,
wherein the remote controller includes:
a light-emitting unit that emits a pairing-set-up request code for requesting a pairing-set-up start to the electronic apparatus using infrared rays;
a first communication unit that receives unique information of the electronic apparatus transmitted from the electronic apparatus using the radio wave in response to the pairing-set-up request code emitted from the light-emitting unit and transmits unique information of the remote controller to the electronic apparatus using the radio wave; and
a first control unit that controls the light-emitting unit and the first communication unit to register the unique information of the electronic apparatus received by the first communication unit and to set the electronic apparatus
as a partner of the pairing; and
wherein the electronic apparatus includes:
a light-receiving unit that receives the pairing-set-up request code for requesting the pairing-set-up start transmitted from the remote controller using infrared rays;
a second communication unit that transmits unique information of the electronic apparatus to the remote controller using the radio wave in response to the pairing-set-up request code received by the light-receiving unit and receives the unique information of the remote controller transmitted from the remote controller using the radio wave; and
a second control unit that controls the light-receiving unit and the second communication unit to register the unique information of the remote controller received by
the second communication unit and to set the remote controller as a partner of the pairing.

10. A remote control system comprising:
a remote controller; and
an electronic apparatus that is remotely controlled by the remote controller, the remote controller setting up a pairing with the electronic apparatus via two-way communications,
wherein the remote controller includes:
a light-emitting unit that emits a pairing-set-up request code for requesting a pairing-set-up start and unique information of the remote controller to the electronic apparatus using infrared rays;
a first communication unit that receives unique information of the electronic apparatus transmitted from the electronic apparatus using the radio wave in response to the pairing-set-up request code emitted from the light-emitting unit; and
a first control unit that controls the light-emitting unit and the first communication unit to register the unique information of the electronic apparatus received by the first communication unit and to set the electronic apparatus as a partner of the pairing; and
wherein the electronic apparatus includes:
a light-receiving unit that receives the pairing-set-up request code for requesting the pairing-set-up start and the unique information of the remote controller, which are transmitted from the remote controller using infrared rays;
a second communication unit that transmits unique information of the electronic apparatus to the remote controller using the radio wave in response to the pairing-set-up request code received by the light-receiving unit; and
a second control unit that controls the light-receiving unit and the second communication unit to register the unique information of the remote controller received by the light-receiving unit and to set the remote controller as a partner of the pairing.
